(19) United States
(12) Patent Application Publication
(10) Pub. No.: US 2002/0069226 A1
(43) Pub. Date: Jun. 6, 2002

(54) Method and apparatus for outputting a table

(76) Inventor: Klaus Peter Thierschmidt, Fuerstenfeldbruck (DE)

Correspondence Address: BELL, BOYD & LLOYD, LLC, P. O. BOX 1135, CHICAGO, IL, 60690-1135, US

(21) Appl. No.: 09/918,050

(22) Filed: Jul. 30, 2001

(30) Foreign Application Priority Data
Jul. 28, 2000 (DE) 100 36 929.4

(51) Int. Cl. G06F 15/00; G06F 17/24; G06F 17/00; G06F 17/21

(52) U.S. Cl. 707/518; 707/509; 707/526

(57) ABSTRACT

A method for outputting a table wherein on the basis of a width value, at least one column is ascertained whose unshortened rendering would exceed the width value. For this column, a number of characters to be rendered is stipulated which is less than the number of characters in the row having the most characters in this column. This method achieves clear rendering of the table on a page.

### BACKGROUND OF THE INVENTION

1. Field of the Invention

The present invention relates to a method and apparatus for outputting a table, to be output on a printer or a screen, wherein the table contains a number of columns. From a prescribed width of the table onward, steps are automatically performed in order to be able to render the table even when the prescribed width is exceeded.

By way of example, the prescribed width is determined by the format which is valid at the time the method is carried out; for example, portrait format or landscape format.

2. Description of the Prior Art

In the program Word 2000, the following steps are automatically performed in order to prevent the prescribed width from being exceeded or to be able to render the table even when the prescribed width is exceeded:

an attempt is first made to reduce the column width of other columns without making any break within a column;

if further characters are input, rows which contain spaces between words are broken up within columns; and

if the two measures mentioned first have been exhausted, the table is automatically extended beyond the edge of the sheet.

Characters situated over the edge are not output on the screen or on a printer. The table is not automatically extended, however, if the user has explicitly prescribed the width of the table.

In the program Excel 2000 from Microsoft, in the event of the output width being exceeded for the selected format, part of the table is automatically pushed onto another page and is rendered or output there.

It is an object of the present invention, therefore, to specify an improved method for outputting a table in which the table is rendered clearly. In addition, an associated apparatus, program, and data medium and data network message containing the program are specified.

### SUMMARY OF THE INVENTION

The present invention is based on consideration of the fact that, in particular instances of application, the known measures make a table more difficult to read. This is because, if too many pages are used for outputting the table, particularly in the row direction, clarity is quickly lost for a user. Secondly, it is often undesirable to break up rows within a column.

For this reason, in the inventive method, a width value is prescribed which stipulates the permissible output width for the columns. On the basis of the width value, at least one column is ascertained whose unshortened rendering would exceed the width value. For this column, a number of characters to be rendered is stipulated which is less than the number of characters in the row having the most characters in this column. When the table is output, only the number of characters stipulated by the number of characters to be rendered is then output. The width of the table can thus be reduced in a simple and very clear manner because use of a number of pages to be placed next to one another is prevented and because the row structure of the table is not changed. The characters not rendered upon output can often still be deduced when reading the table. This is particularly true if the user works with similar data on a daily basis and/or only one or two characters are missing at the end of a word.

The clear rendering of the table when using the inventive method simplifies evaluation in comparison with tables which have been output using the previously known measures, particularly because the clarity is increased.

In an embodiment of the inventive method, the number of characters to be suppressed upon output is determined. Next, a test is carried out for each column in accordance with a prescribed order to determine whether the width value has been exceeded. If such a column is ascertained, the number of characters to be rendered is reduced, before other columns are tested, only by a value which is less than the number of characters to be suppressed upon output. This measure permits the characters which are to be suppressed to be distributed over a number of columns in a simple manner. This allows the user to deduce the content of the columns better than if all the characters to be suppressed are suppressed in only one column or in very few columns. This is because the user would, in this case, have to deduce more characters in the shortened column.

In an embodiment, after a test pass, a test is carried out for all columns to determine whether the number of characters to be rendered has been changed in at least one column. In the event of a change, the test pass is repeated using the same width value. This measure allows the number of characters which are to be rendered to be changed for columns having different widths in the same manner during a test pass. This is because the widths of all columns whose width is greater than the prescribed width value are altered.

In a subsequent embodiment, the width value is decremented, i.e., reduced by the value one, during a test pass if there is no change. The test pass is then repeated. In one alternative, the width value is reduced by a value which is different than one. This allows columns above the respectively valid width value to be shortened in stages in the same way.

In another embodiment, on the basis of the width of the table to be rendered, portrait or landscape format is selected taking into account the characters to be rendered. Portrait format is preferred because it is more common. Changing from portrait format to landscape format makes it possible to prevent a row in the table from needing to be rendered on a number of pages.

In a further embodiment, the columns contain a column heading. The column heading is treated as a row of the column. This measure permits column headings which would ultimately determine the width of a column to be shortened upon rendering without shortening the rendering in the rest of the column. The development is used particularly when the column heading is much longer than the text noted in the column or the numerals noted in the column. The column headings are, thus, incorporated into the method for reducing the rendering. This can be done independently of the other rows in the columns. However, the rendering of the column headings can be shortened in the same way as that of the column content.

In another embodiment, after the number of characters to be rendered has been stipulated for the columns, those column headings whose number of characters is greater than the number of characters to be rendered in the desired column are printed in a legend outside the table. Instead of the column headings, markers are preferably printed in the table; for example, column numbering. The markers are additionally arranged directly next to the column headings in the legend in order to make both the legend and, thus, the table easier to read.

In a subsequent embodiment, a smaller number of characters to be rendered is stipulated for a column only if this does not suppress any numerals upon rendering. This is because the shortened rendering of numeral sequences results in incorrect numerical values which may differ from the original numerical values by orders of magnitude. In addition, missing numerals cannot be deduced. This measure requires that only characters and spaces can be eliminated upon shortened rendering, for example.

The present invention also relates to a program for outputting a table. The program contains a command sequence whose execution by a processor carries out the inventive method or one of its developments. The aforementioned technical effects apply in turn.

The present invention also relates to a data medium which stores the program. The data medium is, by way of example, a memory unit, e.g., a RAM (Random Access Memory), a hard disk, a diskette or a compact disc, commonly called a CD. Protection also covers a data network message which contains the program and is transmitted over a data network; for example, over the Internet.

Additional features and advantages of the present invention are described in, and will be apparent from, the following Detailed Description of the Preferred Embodiments and the Drawings.

### DESCRIPTION OF THE DRAWINGS

FIG. 1 shows a printed table rendered in shortened form;

FIGS. 2A to 2C show method steps for preparing to print the table; and

FIG. 3 shows method steps carried out when printing the table.

### DETAILED DESCRIPTION OF THE PREFERRED EMBODIMENTS

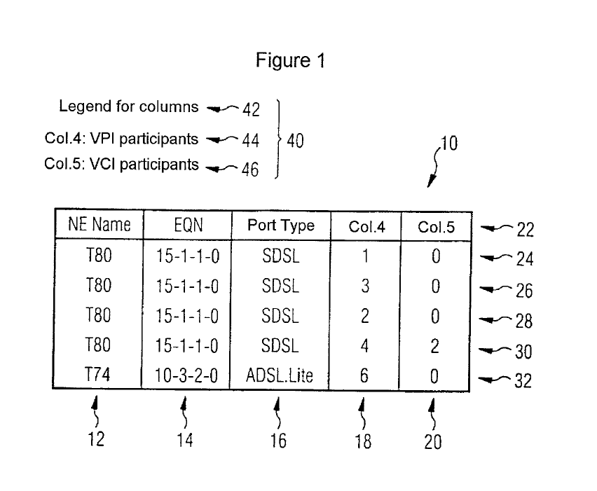

FIG. 1 shows a printed table 10 which is rendered in shortened form and contains five columns 12 to 20. In a column heading row 22, headings for the columns 12, 14 and 16 are printed; namely “NE Name” for the name of a network element, “EQN” for the address of the network element and “Port Type” for the type of interface used. In columns 18 and 20, the column heading row 22 contains two markers “Col.4” and “Col.5,” where Col. is the abbreviation for column. The numerals 4 and 5 number the columns 18 and 20. The effect achieved by the markers Col.4 and Col.5 is that the table 10 still can be printed on portrait format DIN A4. Five rows 24 to 32 of the table 10 have been printed below the column heading row 22.

A legend 40 has been printed above the table 10. The legend 40 contains a legend heading 42 with the text “Legend for the columns”. Below the legend heading 42 are two legend rows 44 and 46. The legend row 44 has the marker Col.4 printed in it. To the right of that, the original column heading for column 18 is specified, namely “VPI participants”, separated from the marker Col.4 by a colon. The legend row 46 has the marker Col.5 printed in it. To the right of that is the original column heading for row 20, namely “VCI participants”, again separated by a colon.

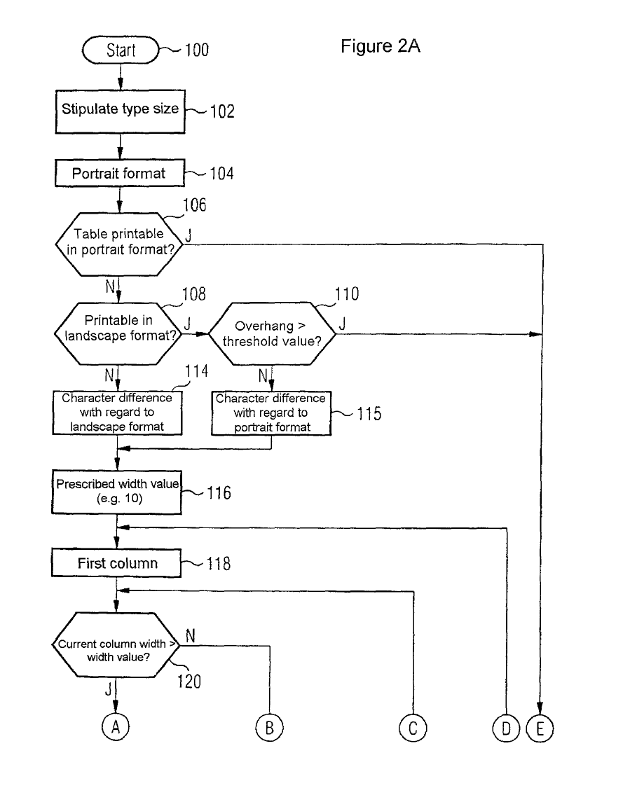

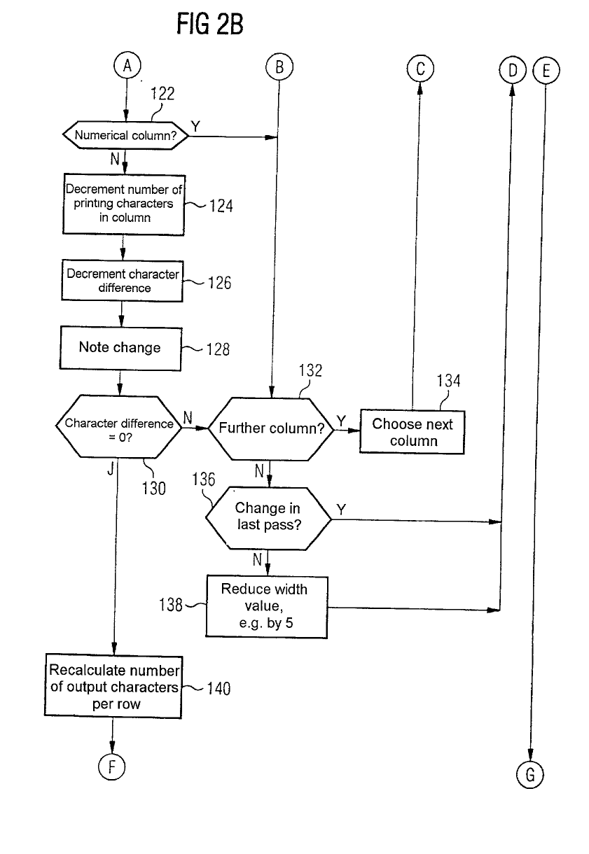

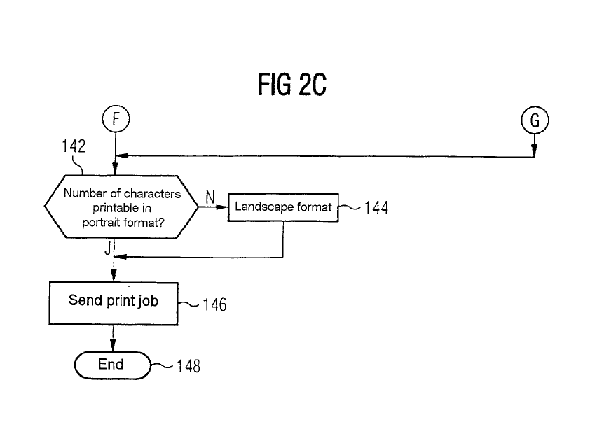

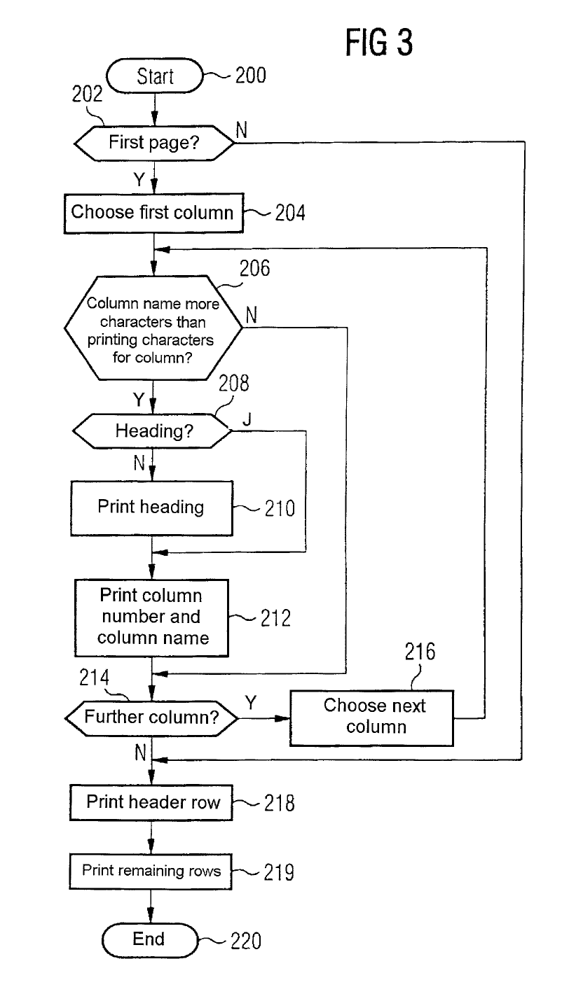

The table 10 was printed using the method explained below with reference to FIGS. 2A to 2C and also to FIG. 3. The width value specified was the value ten, so that the rendering of rows wider than ten characters was first shortened. The column headings were regarded as part of the columns.

FIGS. 2A to 2C show method steps for preparing to print the table 10. The method begins in a method step 100. In a subsequent method step 102, a type size for printing is stipulated. In a preliminary assessment, the character size is chosen within particular limits between a maximum size and a minimum size on the basis of the number of characters to be output per row without correction. The stipulated type size then applies for printing the table. The stipulated type size is also used in the test to determine whether portrait or landscape format needs to be printed, cf. method steps 106, 108 and 142. By way of example, depending on the number of characters per row, 12 Pica are chosen as the type size for up to 100 characters, 11 Pica are chosen for 100 to 200 characters, and 10 Pica are chosen for more than 200 characters.

In a method step 104, the preset chosen for the current format is portrait format. In a subsequent method step 106, a test is carried out to determine whether the table to be printed can be printed in portrait format. In this process, by way of example, the row having the greatest number of characters is ascertained for each column. The numbers of characters ascertained in this manner are added up. The sum is compared with a predetermined value which specifies the number of characters which can be printed next to one another in portrait format using the type size stipulated in method step 102. If the table can be printed in portrait format, no further steps are carried out and the method is ended after the print job has been sent, as explained in more detail below. If, on the other hand, method step 106 establishes that the table cannot be printed in portrait format, a method step 108 immediately follows method step 106. Method step 108 tests whether the table 10 can be printed in full in landscape format. If this is the case, a method step 110 immediately follows method step 108.

Method step 110 tests whether the overhang produced in portrait format is larger than a prescribed threshold value; of ten characters, for example. If this is the case, the method is continued in a method step 112 explained in more detail below.

If, on the other hand, method step 108 establishes that the table cannot be printed in landscape format, an immediately subsequent method step 114 calculates the character difference between the required number of characters and the number of characters available in landscape format. The method is then continued in a method step 116.

If method step 110 establishes that the overhang is less than or equal to the prescribed threshold value, a method step 115 immediately following method step 110 ascertains the character difference between the characters required for printing the table and the available characters for portrait format, because it is necessary to print in portrait format despite the overhang. This likewise requires that the rendering of the table be shortened, however. Method step 115 is then followed immediately by method step 116.

In method step 116, a width value is prescribed; e.g., the value ten or a larger value. By way of example, the width value is stored as a constant in a program whose execution runs the method steps shown in FIGS. 2A to 2C.

In a subsequent method step 118, the first column of the table to be printed is chosen as the column to be processed, e.g., column 12, cf. FIG. 1. A subsequent method step 120 tests whether the column width of the current column is greater than the width prescribed by the width value in the case of unshortened printing. If this is the case, a method step 122 immediately following method step 120 tests whether the current column is a column for rendering numerals. If the current column contains no numerals, a method step 124 follows method step 122. Method step 124 decrements, i.e., reduces by the value one, the number of characters to be printed for the current column. At the start of the method, the number of characters to be printed corresponds to the number of characters required for printing the column in full.

In a subsequent method step 126, the character difference is then decremented. A method step 128 notes that a change to the number of characters to be printed has been made in the current column pass.

Next, a method step 130 tests whether the character difference has the value 0. If this is not the case, a method step 132 follows which tests whether the table to be printed has another column which has not yet been tested. Method step 132 is also carried out immediately after method step 120 if the width of the currently processed column is found to be less than or equal to the width value. If method step 122 establishes that the currently processed column contains numerals, then method step 132 immediately follows method step 122.

If method step 132 establishes that there are still other columns, a method step 134 chooses the column situated to the right of the current column as the current column. The method is then continued in method step 118.

The method is, thus, in a loop which includes method steps 120 to 134. The loop including these method steps 120 to 134 is exited in method step 132 if all the columns in the table to be printed are found to have been processed. In this case, a method step 136 immediately follows method step 132. Method step 136 tests whether the number of characters to be printed has been changed for at least one column in the last pass. This can be established using the note made in method step 128. If changes have been made in the last pass, the method is continued in method step 118. The method is again in the method loop which includes method steps 120 to 134.

If, on the other hand, method step 136 establishes that the number of characters to be printed has not been changed for any column in the last pass, a method step 138 follows immediately. Method step 138 reduces the width value by a prescribed value, e.g., by the value 5. The method is then continued in method step 118. The method subsequently passes through the method loop including method steps 120 to 134 again.

The loop which includes method steps 120 to 134 is also exited in method step 130 if the character difference is found to have the value 0. As such, the number of characters to be printed has been stipulated for the columns such that printing is possible on one page. Method step 130 is followed by a method step 140 if there is a character difference of 0.

In method step 140, the number of characters required for shortened rendering is recalculated. In this context, the number of characters required for printing is added over all the columns. In addition, spaces between the columns are included.

A method step 142 tests whether the number of characters ascertained in method step 140 or the original number of characters from method step 102 can be printed in portrait format on one page in the event of a yes decision in method step 106 or 110. If this is not the case, landscape format is chosen in a method step 144. A method step 146 then sends the print job to a printer. Method step 146 is performed immediately after method step 142 if the number of characters ascertained in step 140 can be printed in portrait format. In this case, portrait format is used for printing. The method is ended in a method step 148.

FIG. 3 shows the method steps performed when printing a table; e.g., the table 10. The method starts in a method step 200 by starting a printing routine when a print job is received.

In a method step 202, the printing routine checks whether the first page of a table is currently being printed. If this is not the case, method steps 218 and 219 print another page of the table and the method is ended in a method step 220. If, on the other hand, method step 202 establishes that the first page of a table needs to be printed, then a test is carried out to determine whether a column legend needs to be inserted. To this end, a method step 204 immediately follows method step 202. Method step 204 selects the first column of the table.

A subsequent method step 206 ascertains the column name for the current column. The number of characters in the column name is determined and is compared with the number of characters to be printed. This number has been determined using the method explained above with reference to FIGS. 2A to 2C. If the column name contains more characters than there are printing characters available for the column, a method step 208 follows method step 206. Otherwise, the method is continued in a method step 214 explained below.

Method step 208 uses a note to test whether a legend heading has already been printed. If this is not the case, a method step 210 prints the heading for the legend, cf. heading 42 in FIG. 1, for example. In addition, printing of the legend heading is noted. If the legend heading has already been printed, method step 210 is skipped. Next, a method step 212 prints the column number for the current column and the column name for this column in the next row, cf. legend row 44 in FIG. 1, during the fourth pass of the loop including method steps 206 to 216.

A method step 214 tests whether the table to be printed has further columns. If this is the case, a method step 216 chooses the column situated to the right of the current column as the current column. The method is then continued in method step 206. The method is now in a loop which includes method steps 206 to 216.

The loop including method steps 206 to 216 is exited in method step 214 when all the columns have been processed. In this case, method step 214 is followed immediately by a method step 218, in which the column heading row of the table is printed, cf. column heading row 22 in FIG. 1, for example. Markers are inserted for the column headings which have already been printed in the legend. In a subsequent method step 219, the remaining rows of the table are printed. In this process, the columns stipulated using the method explained above with reference to FIGS. 2A to 2C are output in shortened form. When further pages of the table are printed, the column heading row is output at the top of each page, cf. method step 218. The method is then ended in a method step 220.

In another exemplary embodiment, the characters of the character set do not have the same width, but rather have different printing widths; i.e., a proportional script is used for printing. In this case, a similar method is carried out. However, method steps 102, 106, 108, 110, 114, 115, 126 and 130 refer to pixel numbers. Method steps 116 and 124 work unchanged with characters. Between method steps 124 and 126, a method step is performed for ascertaining the number of pixels in the row direction of the character to be suppressed. In the method in accordance with the second exemplary embodiment, the printing width and not the number of characters is, thus, tested before the number of characters to be output is reduced.

Although the present invention has been described with reference to specific embodiments, those of skill in the art will recognize that changes may be made thereto without departing from the spirit and scope of the invention as set forth in the hereafter appended claims.

I claim as my invention:

1. A method for outputting a table, which contains a plurality of columns, on at least one of a printer and a screen even when a prescribed width of the table has been exceeded, the method comprising the steps of:
ascertaining, based on the prescribed width value, at least one column whose unshortened rendering would exceed the prescribed width value; and
stipulating, for the column, a number of characters to be rendered which is less than a number of characters in a row having the most characters in the one column.

2. A method for outputting a table as claimed in claim 1, a method further comprising the steps of:
determining a number of characters to be suppressed upon output;
carrying out a test for the plurality of columns in accordance with a prescribed order to determine whether the prescribed width value has been exceeded; and
reducing, for an ascertained column, a number of characters to be rendered, before other columns are tested, only by a value which is less than the number of characters to be suppressed upon output.

3. A method for outputting a table as claimed in claim 2, the method further comprising the steps of:
carrying out a test, after a test pass, for the plurality of columns to determine whether the number of characters to be rendered has been changed in at least one column; and
repeating the test pass, in the event of the change, using the same width value.

4. A method for outputting a table as claimed in claim 3, the method further comprising the step of:
decrementing the width value in the test pass if there is no change.

5. A method for outputting a table as claimed in claim 1, the method further comprising the step of:
selecting, automatically, one of a portrait and a landscape format based on the width of the table when rendered in shortened form.

6. A method for outputting a table as claimed in claim 1, wherein the plurality of columns contain a column heading, and the column heading is treated as a row of the column when the rendering is shortened.

7. A method for outputting a table as claimed in claim 6, the method further comprising the steps of:
printing column headings for the columns outside the table, after the number of characters to be rendered has been stipulated, wherein the number of characters in the column headings is greater than the number of characters to be rendered in the respective column; and
printing markers in the table instead of the column headings.

8. A method for outputting a table as claimed in claim 1, wherein a smaller number of characters to be rendered is stipulated for a column only if it does not eliminate any numerals upon rendering.

9. A program for outputting a table, which contains a plurality of columns, on at least one of a printer and a screen even when a prescribed width of the table has been exceeded, the program comprising a command sequence whose execution by a processor reads at least one of data and a length of data fields in the table to be output and, if the prescribed width of the table is exceeded, steps are automatically performed to render the table despite the prescribed width having been exceeded, wherein, based on the prescribed width value, at least one column is ascertained whose unshortened rendering would exceed the prescribed width value, and wherein, for the column, the plurality of characters to be rendered is stipulated which is less than a number of characters in a row having the most characters in the column.

10. A program for outputting a table as claimed in claim 9, wherein, upon execution of the command sequence, a number of characters to be suppressed upon output is determined, a test is carried out for the plurality columns in accordance with a prescribed order to determine whether the width value has been exceeded and, for an ascertained column, a number of characters to be rendered is reduced, before other columns are tested, only by a value which is less than the number of characters to be suppressed upon output.

11. A data medium for storing a program for outputting a table, which contains a plurality of columns, on at least one of a printer and a screen even when a prescribed width of the table has been exceeded, the program comprising a command sequence whose execution by a processor reads at least one of data and a length of data fields in the table to be output and, if a prescribed width of the table is exceeded, steps are automatically performed to render the table despite the prescribed width having been exceeded, wherein, based on the prescribed width value, at least one colunm is ascertained whose unshortened rendering would exceed the prescribed width value, and wherein, for the column, a plurality of characters to be rendered is stipulated which is less than a number of characters in a row having the most characters in the column.

12. A data network message containing a program for outputting a table, which contains a plurality of columns, on at least one of a printer and screen even when a prescribed width of the table has been exceeded, the program comprising a command sequence whose execution by a processor reads at least one of data and a length of data fields in the table to be output and, if the prescribed width of the table is exceeded, steps are automatically performed to render the table despite the prescribed width having been exceeded, wherein, based on the prescribed width value, at least one column is ascertained whose unshortened rendering would exceed the prescribed width value, and wherein, for the column, a plurality of characters to be rendered is stipulated which is less than a number of characters in a row having the most characters in the column.
